(19) United States
(12) Patent Application Publication
(10) Pub. No.: US 2026/0100000 A1
(43) Pub. Date: Apr. 9, 2026

(54) SYSTEMS AND METHODS FOR GENERATION AND VISUALIZATION OF PERSONALIZED THREE-DIMENSIONAL SPECTACLES MODELS

(71) Applicant: WARBY PARKER INC., New York, NY (US)

(72) Inventors: Dee Celeste Goldberg, New York, NY (US); Ravi C. Jindal, New York, NY (US)

(73) Assignee: WARBY PARKER INC., New York, NY (US)

(21) Appl. No.: 19/349,191

(22) Filed: Oct. 3, 2025

Related U.S. Application Data
(60) Provisional application No. 63/703,307, filed on Oct. 4, 2024.

(51) Int. Cl. G06T 17/10

(52) U.S. Cl. CPC G06T 17/10

(57) ABSTRACT

A system includes a processor, an input device, an output device, a memory, and programming in the memory. Execution of the programming by the processor configures the system to perform the following functions. The system obtains a measurement associated with a user. The system determines a focal length of a three-dimensional lens based on the measurement, the three-dimensional lens including a lens perimeter face intersecting a lens frontal plane. The system obtains a three-dimensional spectacles model including a rim inner face intersecting a spectacle frontal plane. The system determines a lens contour of the lens perimeter face, the lens contour conforming to the rim inner face. The system determines a rim contour of the three-dimensional spectacles model, the rim contour conforming to the focal length. The system produces a validity report indicating conformance between the determined rim contour and the determined lens contour.

### CROSS-REFERENCE TO RELATED APPLICATIONS

This application claims priority to U.S. Provisional Patent Application No. 63/703,307, filed Oct. 4, 2024, the entirety of which is incorporated by reference herein.

### FIELD

The present disclosure relates to generating three-dimensional models of spectacles with embedded lenses, the generated lenses accurately shaped to conform with the rims of the spectacles, and the generated spectacles accurately deformed based on the shape of the generated lenses, in order to inform improved selection and fabrication of fitted spectacles.

### BACKGROUND

In order to visualize how a particular item would look on an individual, virtual try on methods have been implemented to place a virtual item on an item or a video of an individual. However, these virtual try on methods do not personalize the virtual item to the individual. In particular, physical lenses in physical spectacles are shaped depending upon physical characteristics of the intended individual, and those physical spectacles are further shaped by those physical lenses. Existing virtual try on methods do not capture or represent changes to the virtual lenses or spectacles based on the physical characteristics of the individual. Further, existing methods do not allow users or individuals to view these personalized virtual items privately or in isolation. Parties such as opticians, manufacturers, or lens mounters may want to better understand the manufacturability of certain combinations of frame and lens parameters.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method may include obtaining a refractive error measurement associated with a user. The method may further include determining a focal length of a three-dimensional lens based on the measurement, the three-dimensional lens including a lens perimeter face intersecting a lens frontal plane. The method may also include obtaining a three-dimensional spectacles model, the three-dimensional model including a rim inner face intersecting a spectacle frontal plane. The method may further include determining a lens contour of the lens perimeter face, the lens contour conforming to the rim inner face. The method additionally may include determining a rim contour of the three-dimensional spectacles model, the rim contour conforming to the focal length. The method may yet further include producing a validity report, the validity report indicating conformance between the three-dimensional spectacles model with the determined rim contour, and the three-dimensional lens with the determined lens contour.

In some aspects, the validity report may include a depiction of a virtual representation of the three-dimensional spectacles model with the determined rim contour, the three-dimensional lens with the determined lens contour, and the lens perimeter face in contact with the rim inner face.

In further aspects, the three-dimensional spectacles model may include a second rim inner face intersecting the model frontal plane. The method also may include obtaining a second refractive error measurement associated with the user. The method may include determining a second focal length of a second three-dimensional lens based on the second measurement, the three-dimensional lens including a second lens perimeter face intersecting a second lens frontal plane. The method additionally may include determining a second lens contour of the second lens perimeter face, the second lens contour conforming to the second rim inner face. The method may yet further include determining a second rim contour of the three-dimensional spectacles model, the second rim contour conforming to the second focal length. In addition, the method may include displaying a virtual representation of the three-dimensional spectacles model with the determined rim contour and the determined second rim contour, the three-dimensional lens with the determined lens contour, the second three-dimensional lens with the determined second lens contour, the lens perimeter face in contact with the rim inner face, and the second lens perimeter face is in contact with the second rim inner face.

In some aspects, the visual representation may be depicted from a first perspective. The method may further include receiving input correlated to a rotation of the visual representation to a second perspective. The method also may include depicting the visual representation from the second perspective.

In some aspects, the method may include obtaining a refractive index of the three-dimensional lens. The method may also include determining the focal length of the three-dimensional lens based on the measurement and the refractive index.

In some aspects, the method may include obtaining a lens thickness threshold. The method may include determining a thickness value of the three-dimensional lens. The method may include, based on the thickness value exceeding the lens thickness threshold, indicating a high thickness status.

In some aspects, the method may include obtaining a lens protrusion threshold. The method also may include determining a protrusion value of the three-dimensional lens when the lens perimeter face is in contact with the rim inner face. The method may include, based on the protrusion value exceeding the lens protrusion threshold, indicating a high protrusion status.

In some aspects, the three-dimensional spectacles model may include a hinge. The method also may include determining an interference threshold based on a depth of the hinge. The method may include determining a lens back depth value of the three-dimensional lens when the lens perimeter face in contact with the rim inner face based on the lens back depth value exceeding the interference threshold indicating a high interference status.

In some aspects, the three-dimensional spectacles model corresponds to a physical pair of spectacles, the three-dimensional lens corresponds to a physical lens, configured to improve vision of the user, and the virtual representation corresponds to the physical pair of spectacles including the physical lens.

In some aspects, a modeled parameter of the three-dimensional lens may be calculated according to an equation. In addition, a manufacturing parameter of the physical lens is calculated according to the equation. Further, the parameter may be the focal length, the determined contour, or a combination thereof.

In some aspects, the three-dimensional spectacles model may be obtained from an input file in a modeling format. Additionally, the validity report may include a virtual representation of the three-dimensional spectacles model with the determined rim contour, the three-dimensional lens with the determined lens contour, and the lens perimeter face in contact with the rim inner face, all in the modeling format.

In some aspects, the method may include determining a sagittal plane of the three-dimensional lens based on a top thickness, a bottom thickness, and a center thickness. The method also may include determining a coronal plane of the three-dimensional lens based on a left thickness, a right thickness, and the center thickness. The method may include determining a lens surface based on the sagittal plane and the coronal plane. The validity report may indicate conformance between the three-dimensional spectacles models with the determined rim contour, and the three-dimensional lens with the determined lens contour and the determined lens surface.

In some aspects, determining a lens contour of the lens perimeter face, the lens contour conforming to the rim inner face, may include selecting one or more edge facets of lens facets of the three-dimensional lens, the one or more edge facets including an edge normal vector approximately oriented towards a geometric center of the three-dimensional lens and approximately perpendicular to a sagittal axis. Additionally, the determining may include determining a convex hull based on the one or more edge facets. Still further, the determining may include selecting one or more surface facets of the rim inner face, the one or more surface facets including a surface normal vector approximately oriented toward the sagittal axis. Also, the determining may include determining one or more line segments, the one or more line segments resulting from intersections between the one or more edge facets and the one or more surface facets. The determining also may include, based on the one or more line segments and the convex hull, determining the lens contour.

In further aspects, determining the rim contour of the three-dimensional spectacles model, the rim contour conforming to the focal length, may include determining a base front radius of curvature of the three-dimensional spectacles associated with the inner rim, and a base back radius of curvature of the three-dimensional spectacles model associated with the inner rim. The determining also may include calculating a lens front radius of curvature of the three-dimensional lens based on the focal length, and a lens back radius of curvature based on the focal length. The determining may include updating the one or more surface normal vectors based on a first variation between the base front radius of curvature and the lens front radius of curvature, and a second variation between the base back radius of curvature and the lens back radius of curvature. The determining may additionally include determining the rim contour based on the updated one or more edge normal vectors.

In further aspects, the three-dimensional spectacles model includes an arm with an original arm angle. The method also may include, based on the updated one or more edge normal vectors, determining an updated arm angle. The method may include, based on the updated arm angle, calculating an arm rotation angle of the arm, the arm rotation angle and the updated arm angle equal to the original arm angle.

A method may include obtaining a measurement associated with a user. The method may further include determining a shape depth of a three-dimensional shape based on the measurement, the three-dimensional shape including a shape outer face intersecting a shape frontal plane. The method may include obtaining a three-dimensional model, the three-dimensional model including a model inner face intersecting a model frontal plane. The method also may include determining a shape contour of the shape outer face, the shape contour conforming to the model inner face. The method may additionally include determining a model contour of the three-dimensional model, the model contour conforming to the shape depth. The method may further include displaying a virtual representation of the three-dimensional model with the determined model contour, the three-dimensional shape with the determined shape contour, and the shape outer face in contact with the model inner face.

In some aspects, the method may include obtaining a measurement associated with a user. The method also may include determining a shape depth of a three-dimensional shape based on the measurement, the three-dimensional shape including a shape outer face intersecting a shape frontal plane. The method may include obtaining a three-dimensional model, the three-dimensional model including a model inner face intersecting a model frontal plane. The method additionally may include determining a shape contour of the shape outer face, the shape contour conforming to the model inner face. The method may yet further include determining a model contour of the three-dimensional model, the model contour conforming to the shape depth. Additionally, the method may include producing a validity report, the validity report indicating conformance between the three-dimensional model with the determined model contour, and the three-dimensional shape with the determined shape contour.

In some aspects, determining a shape contour of the shape outer face, the shape contour conforming to the model inner face, may include selecting one or more edge facets of lens facets of the three-dimensional shape, the one or more edge facets may include an edge normal vector approximately oriented towards a geometric center of the three-dimensional shape and approximately perpendicular to a sagittal axis. Additionally, the determining may include determining a convex hull based on the one or more edge facets. Still further, the determining may include selecting one or more surface facets of the model inner face, the one or more surface facets including a surface normal vector approximately oriented toward the sagittal axis. Also, the determining may include determining one or more line segments, the one or more line segments resulting from intersections between the one or more edge facets and the one or more surface facets. The determining may yet further include, based on the one or more line segments and the convex hull, determining the lens contour.

In further aspects, determining the model contour of the three-dimensional model, the model contour conforming to the shape depth, may include determining a base front radius of curvature of the three-dimensional model associated with the inner rim, and a base back radius of curvature of the three-dimensional spectacles model associated with the model inner face. The determining also may include calculating a shape front radius of curvature of the three-dimensional shape based on the shape depth, and a shape back radius of curvature based on the focal length. The determining may still further include updating the one or more surface normal vectors based on a first variation between the base front radius of curvature and the shape front radius of curvature, and a second variation between the base back radius of curvature and the shape back radius of curvature. The determining additionally may include determining the model contour based on the updated one or more edge normal vectors.

A system may include a processor, an input device coupled to the processor, an output device coupled to the processor, a memory coupled to the processor, and programming in the memory. Execution of the programming by the processor configures the system to perform the following functions. The system may obtain a refractive error measurement associated with a user. The system may determine a focal length of a three-dimensional lens based on the measurement, the three-dimensional lens including a lens perimeter face intersecting a lens frontal plane. The system may obtain a three-dimensional spectacles model, the three-dimensional model including a rim inner face intersecting a spectacle frontal plane. The system may determine a lens contour of the lens perimeter face, the lens contour conforming to the rim inner face. The system may determine a rim contour of the three-dimensional spectacles model, the rim contour conforming to the focal length. The system may produce a validity report, the validity report indicating conformance between the three-dimensional spectacles model with the determined rim contour, and the three-dimensional lens with the determined lens contour. The validity report may be output by the system, such as printed and/or displayed on a display. In some embodiments, the validity report may be stored in a non-transient machine readable storage medium. The system may be a distributed system in which processing is performed by multiple disparate computing devices that are communicatively coupled together. In some embodiments, the system may be a single device that performs each of the various processes.

A computer-implemented method may include obtaining an unadjusted spectacles frame model and an unadjusted lens model. The method may further include determining a lens measurement. The method may also include producing an adjusted lens model based upon the lens measurement and the unadjusted lens model. The method may additionally include producing an adjusted spectacles frame model based upon the unadjusted spectacles frame model and the adjusted lens model.

In some aspects, the method may include combining the adjusted lens model and the adjusted spectacles frame model to produce an adjusted spectacles model.

In some aspects, the lens measurement is a lens prescription, a refractive error measurement, a diopter measurement, a sphere power measurement, a focal length measurement, or a requisite lens power measurement.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a flowchart depicting one example of a model generation protocol and method in accordance with some embodiments.

FIG. 1B is a flowchart depicting one example of a lens boundary preprocessing protocol and method in accordance with some embodiments.

FIG. 1C is a flowchart depicting one example of a prescription lens depth adjustment sub-protocol and method in accordance with some embodiments.

FIG. 1D is a flowchart depicting one example of a frame adjustment to personalized lenses sub-protocol and method in accordance with some embodime.

FIG. 2A is a graphical mesh rendering of one example of a spectacles model including two lenses in accordance with some embodiments.

FIG. 2B is one example of a graphical mesh rendering of a lens in accordance with some embodiments.

FIG. 3A is a graphical rendering of one example of a front face and a back face demonstration lens in accordance with some embodiments.

FIG. 3B is a graphical rendering of one example of a front face and a back face personalized lens in accordance with some embodiments.

FIG. 4 is a graphical textured rendering of one example of a spectacles model including two lenses with hinges in accordance with some embodiments.

FIG. 5A is a graphical textured rendering of one example of a corner of a spectacles model including a lens, focused on a projection of the lens from a rim of the spectacles model in accordance with some embodiments.

FIG. 5B is a graphical textured rendering of one example of a corner of a spectacles model including a lens, focused on a reduced projection of the lens from the rim of the spectacles model in accordance with some embodiments.

FIG. 6 is one example of a diagram of a lens thickness approximation rectangle in accordance with some embodiments.

FIG. 7A is one example of a rendering of a spectacles model including lenses representative of a −2 diopter measurement in accordance with some embodiments.

FIG. 7B is one example of a rendering of the spectacles model of FIG. 7A, including lenses representative of a −6 diopter measurement in accordance with some embodiments.

FIG. 7C is one example of a rendering of the spectacles model of FIG. 7A, including lenses representative of a +4 diopter measurement in accordance with some embodiments.

FIG. 8 is one example of a block diagram of one example of an architecture of a computing device that may be used in a system to implement a protocol, in accordance with some embodiments in accordance with some embodiments.

FIG. 9 is a block diagram of one example of an architecture of a computing device 900 that may be used in a system to assist or partially implement a protocol, in accordance with some embodiments.

In the drawings, reference numbers may be reused to identify similar and/or identical elements.

### DETAILED DESCRIPTION

A virtual try on system may be implemented as an augmented reality tool that enables customers to see how a spectacles frame (or other wearable object) will look on their face. The appearance of spectacles depends subtly but importantly on the strength of a customer's prescription, the lens material, the customer's pupillary distance, and the customer's optical center height. The virtual try on system modifies 3D models so that those models more accurately represent what a customer would receive as a delivered physical product. The modeled lens shapes may be generated according to the same mathematical formulae used by lens manufacturers, and the face fronts of the spectacles are bent to accommodate any difference between the lenses' base curve and the nominal base curve—or the modeled lens shape may be generated based on empirical or modeled lens data from lens manufacturers. The resulting modified 3D model can be used to generate either photorealistic or schematic visualizations, whether they be augmented reality or a rendered still image. The modified 3D model may then be used in selecting lens materials based on their indices of refraction for customers with strong prescriptions; may be used in selecting spectacle frame styles based on the frame width and the pupillary distance of the customer, or based on the frame rim thickness and the prospective lens thickness.

While the following description is provided with reference to a try on system for spectacles, it should be understood that the concepts disclosed herein may be used for other purposes. For example, the systems and methods described herein may be used to modify a first model and distort, stretch, or deform that model based on the shape of a second model. Additionally, the methods may also be used to alter the edges or shape of the second model to conform to a boundary or perimeter of the first model, potentially avoiding collisions between the first model and the second model. The augmented model, i.e., a model or models in which the first model has been modified by a shape of a second model, may then be displayed or otherwise presented to a user or other individual, or may be used by fabrication equipment or fabricators to produce the first model in either the modified or unmodified configuration, as well as the second model in either an altered or unaltered configuration. In particular, fabricators may use the augmented model to determine or aid in determining whether a particular combination of prescription, spectacle style, and lens material are manufacturable.

In some embodiments, the present virtual try on system makes use of photorealistic three-dimensional (3D) models of a variety of spectacles, typically generated in an industry standard file format for 3D scenes and models, such as the graphics library transmission format (gITF), Filmbox format (FBX), or Wavefront™ object geometry format (OBJ). The model files are read into the system, which uses details about a customer's prescription and preferences to modify the read 3D model in order to write out a revised and personalized 3D model, in either the original file format, a different file format, or a standardized file format. The system may also generate still images, video, or manipulable renderings from one or more views based on that revised 3D model.

Lenses, frames, spectacles, and models thereof may be generated or visualized in any number of formats for any number of reasons. Lenses and spectacles may be generated or visualized with certain traits. The traits may be singular traits; discrete traits with one or more values in one or more positions within or upon the lenses or spectacles; as well as continuous traits described by values along two- or three-dimensional continuums, across or through the lenses or spectacles. Traits may include clarity; density; surface finish including grind or polish; material or materials; coating or coatings; concavity; convexity; an axis or axes of light travel; a facet or facets; reflectivity; refractivity; color; thermal or electrical insularity; viscosity; schedules or processes for casting, molding, forming, machining, or printing; schedules or processes for annealing; quality or quantity of induced optical aberrations; as well as any other traits generally describing physical phenomena or methods of modification or manufacture of phenomena.

Certain lens or spectacles traits may be generated or visualized in furtherance of designing or modeling lenses, spectacles, or lens equipment (either in use of lenses, or for manufacturing of lenses) for the adjustment of vision to improve recognition of illuminated objects or phenomena. The improvement may be directed to improving human vision for persons with vision disorders, including myopia, hyperopia, astigmatism, presbyopia, strabismus, cataracts, glaucoma, macular degeneration, retinal detachment, or other conditions, scenarios, or environments which impact human vision. The improvement may also be made to non-disordered vision, improving vision beyond what is considered typical performance. The improvements may also be applied to non-human vision, including animal, biological, or mechanical-electrical machine vision, thereby improving the capacity of a non-human to recognize illuminated objects or phenomena.

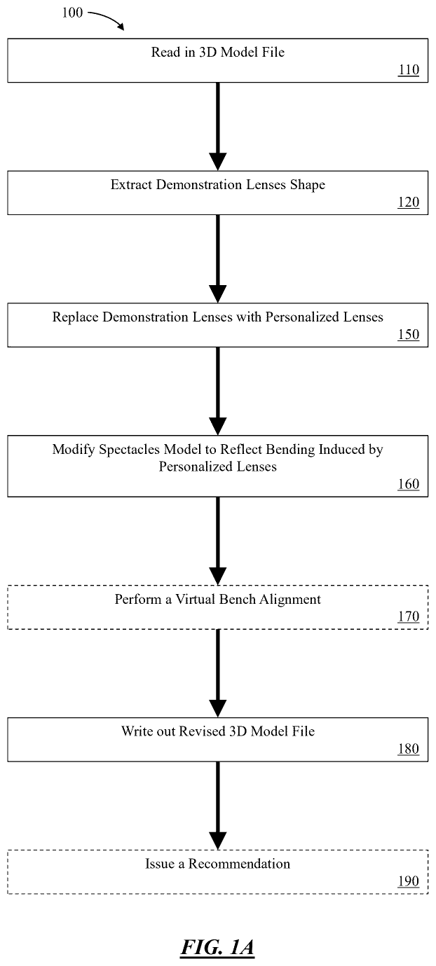

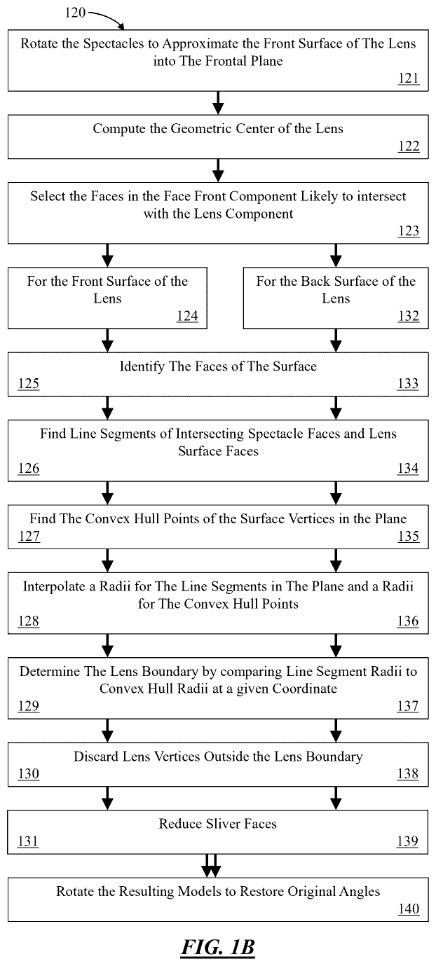

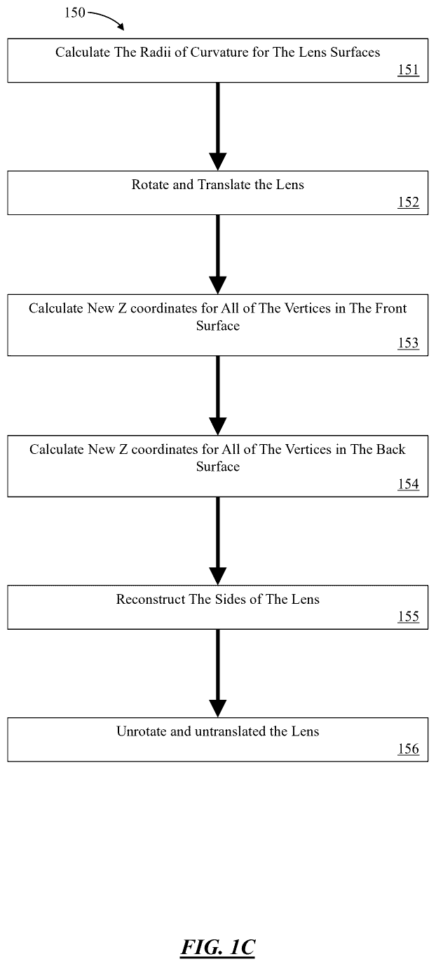

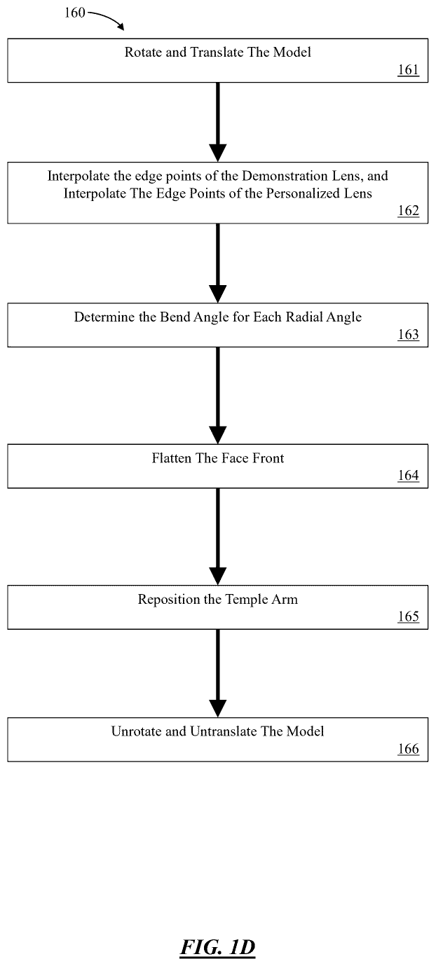

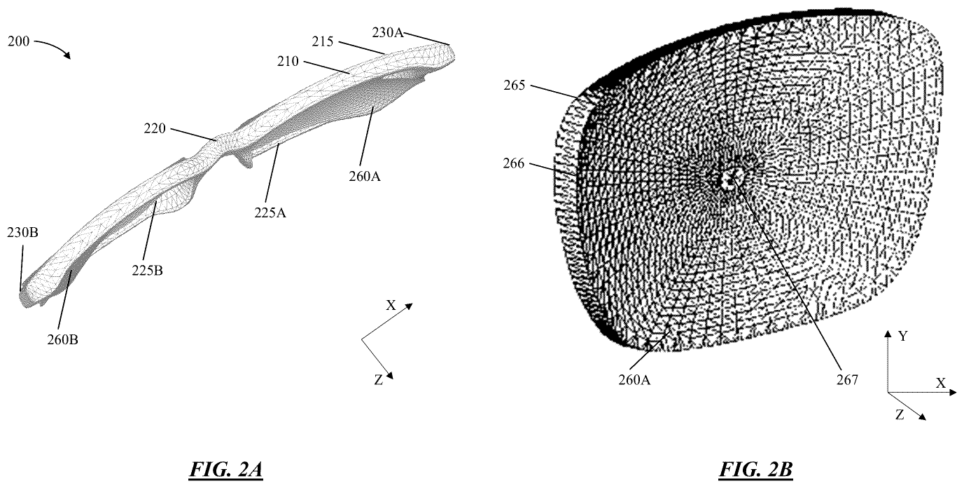

FIG. 1A is a flowchart depicting one example of a model modification protocol 100 process in accordance with some embodiments. FIGS. 2A-B are graphical renderings of a spectacles model 200 including two lenses 260A-B, and the lens 260A itself. The protocol 100 may be implemented in a virtual try on system (described herein) and may comprise several operations or processes, some of which may be skipped, added to, or reordered in certain embodiments. First, in block 110 the 3D model file of the spectacles 200, which include demonstration lenses 260A-B, is read into the system. Next, in block 120, the lens shape may be extracted from the model file by ascertaining the intersection between the face front of the spectacles model and the demonstration lenses 260A-B. In block 150, personalized lenses 260A-B′ corresponding to a customer's prescription replace the demonstration lenses 260A-B of the spectacles model 200. Block 160 may include modifying the face front of the spectacles model 200 to show the bending resulting from a shape difference between the demonstration lenses 260A-B and the personalized lenses 260A-B′. In block 170, some embodiments may include performing a virtual bench alignment, in which the modified spectacles model 200′, including the modified frame 210′ and the modified lenses 260A-B′, conform to quality control standards similar to those for physical spectacles. Next, in block 180, the modified model 200′ may be analyzed and assessed regarding whether the material utilized in the personalized lenses 260A-B′ is appropriate for the spectacles frame 210, and for the customer's prescription. In some embodiments, block 190 may include considering multiple customized spectacle models, with varying frame styles, lens materials, and prescriptions, in order to issue a recommendation for one or more suitable selections.

Returning to block 110, reading the 3D model file of the spectacles model 200, which include demonstration lenses 260A-B, is performed. In certain embodiments, spectacle models are stored in a standardized format, such as the glTF format. The formatted file can include a hierarchical arrangement of components, such as the spectacle frames 210 and the demonstration lenses 260A-B. Throughout this disclosure, unless otherwise specified, the models are described within a Cartesian coordinates system, such that a hypothetical wearer of the spectacles looks through the lenses from the back towards the front. Therefore, the positive x axis (also referred to as the frontal axis) of the coordinate system points to the right and is perpendicular to a sagittal plane; the positive y axis (also referred to as the longitudinal axis) of the coordinate system points up and is perpendicular to a transverse plane; and the positive z axis (also referred to as the sagittal axis) of the coordinate system points toward the wearer, or the back, and is perpendicular to the frontal plane; the origin of the coordinate system in this disclosure, unless otherwise specified, is set at the bottom center of the bridge of the spectacles.

The model files may be read in and stored in a mesh data structure, which can be visually represented as the spectacle model 200 of FIG. 2A. The spectacle model 200 generally may include two lenses 260A-B, which are demonstration lenses 260A-B. The model 200 may include the frame bridge 220, the spectacle frame 210, the spectacle face front 215, as well as spectacle rims 225A-B. The mesh data structure includes vertices, faces, vertex normal, texture coordinates, and child meshes, which can include lenses 260A-B. FIG. 2B, is one example of a visual representation of a mesh data structure of lens 260A in accordance with some embodiments. In both FIGS. 2A and 2B, mesh faces are generally triangular planar areas bounded by three vertices. Vertices exist in three-dimensional space, and two mesh faces sharing a vertex may not be parallel planes. The mesh data structure of the spectacle model 200 is representative of the physical structure of a corresponding physical pair of spectacles, which may be obtained by the customer or another user.

In some examples, it is possible that the spectacle model 200 does not include data, either models or equations, describing lenses 260A-B. In such examples, the protocol using the spectacle model 200 may be expected to insert or presume standardized lenses. When using such models 200, model modification protocol 100 may either insert or derive standardized lenses which would generally or exactly fit within spectacle model 200, in order to allow blocks 120-190 to proceed. Alternatively, model modification protocol 100 may only derive, model, or render the minimum required information needed for blocks 120-190 to proceed, e.g., the geometric center of the nonexistent lens, line segment radii values and convex hull radii values, etc. Minimum required information may vary based on the design of the model 200, and the requirements of the final output.

At block 120, extracting the lens shape from the model file is performed. In some read models 200, the lens 260A-B components are not always shaped to fit exactly into the rims 225A-B of the face front 215. In those models 200, the spectacle frame 210 model component may obscure any overlap or collision with the lenses 260A-B, making such overlap invisible when rendering the model 200. However, for the operation performed later at block 150, i.e., bending the spectacle frame 210 model to conform to the lenses 260A-B in order to accurately represent physical spectacles, there may not be any overlap. This is because, in physical space, physical lenses cannot simply phase through physical spectacles and occupy overlapping space, based on at least the Pauli Exclusion Principle, electrostatic repulsion, and the second law of thermodynamics. So too, the final model 200 may conform with those laws of nature in the simulated space in order to accurately simulate physical spectacles embedded with physical lenses, despite the virtualized environment, file format, and mesh models accepting collided virtual objects.

In order to accomplish this, the model 200 may undergo preprocessing. One example of a flowchart of preprocessing is depicted in FIG. 2B. The preprocessing may be performed on each lens, although the following description describes the process for preprocessing a single lens 260A. It should be understood that the preprocessing can be repeated for an additional lens 260B. Some preprocessing blocks may be combined when processing multiple lenses: however, as the front surface 265 as well as the geometric center 267 of each lens 260A-B is likely different, many of the preprocessing blocks will need to be re-performed for an additional lens 260B.

In preprocessing block 121, the model 200 is rotated so that the front surface 265 of the lens 260A is approximately parallel to the frontal plane. Approximate values for the pantoscopic angle and head curve angle are used to calculate the appropriate rotation. Next, in preprocessing block 122, the geometric center 267 of the lens 260A is calculated. In order to ease further calculations, the coordinates of the model 200 are translated so that the geometric center 267 resides at the origin.

At block 123, the faces of the face front 215, which are likely to intersect with the lens 260A, may be selected by determining which face front 215 faces have a normal vector that are both approximately oriented toward the center of the opening created within the rim 225A, and which are not generally aligned with the z axis. The orientation toward the center of the opening created within the rim 225A may be determined by calculating a positive dot product between the normal vector of the respective face, and a vector originating at the same origin as that normal vector, pointing toward the center of the opening within the rim 225A. Misalignment with the z axis may be determined by a z component of the normal vector having a magnitude less than 0.5. In some embodiments, where the model equivalent to the lens 260A does not include two major faces that are largely parallel, alignment and orientation with the model equivalent to the frame 210 may be performed using alternative or additional criteria.

Next, the preprocessing may perform a number of operations a plurality of times: once 124 for the front surface 265 of the lens 260A (preprocessing blocks 125-131) and once 132 for the back surface 266 of the lens 260A (preprocessing blocks 133-139). It should be understood that the order of the operations may be varied and that other operations may be performed. For example, these two sequences 124, 132 may be performed in series with one another, or in parallel with one another. In other embodiments, the processing of potentially colliding surfaces 265-266 of a modeled object could include one, three, or more surfaces, depending upon the requirements of the collided object.

In preprocessing block 125, similar to preprocessing block 123, the faces of the lens 260A that correspond to the front surface 265 are selected by selecting those faces with normal vectors with a z component greater than 0.5, and therefore generally facing forward.

In preprocessing block 126, the line segments resulting from intersections between the selected faces of the lens 260A from preprocessing block 125 and the faces of rim 225A are identified. In some embodiments, all of the line segments resulting from the intersections may be identified, although fewer than all line segments may be identified in some embodiments. In order to determine whether a pair of faces intersect, an intersection algorithm may be used: for example, the Badouel ray-triangle intersection algorithm, the Baldwin-Weber ray-triangle intersection algorithm, or the Moller-Trumbore intersection algorithm, potentially modified to accept two planes rather than a ray and a plane, and to report only the presence of a collision between the two faces in the pair.

In preprocessing block 127, the convex hull of the vertices of the faces in the frontal plane 265 may be calculated. As the faces in the frontal plane 265 are determined in preprocessing block 125, preprocessing block 127 may be performed before or in parallel to preprocessing block 126.

With the operations of both preprocessing blocks 126 and 127 completed, the x and y coordinates of the convex hull from block 127, as well as of each identified line segment from block 126, may be converted to polar coordinates, centered on the geometric center 267 in preprocessing block 128. Thus, the line segments can be described by two points, each including a pair of polar coordinates, and a z coordinate. Likewise, points along the convex hull can also be described by a pair of polar coordinates, and a z coordinate. Next, points among the line segments may be interpolated at regular angular intervals along the polar coordinates, resulting in interpolated polar coordinates paired with interpolated z coordinates. Additionally, points along the convex hull also may be interpolated at the same regular angular intervals along the polar coordinates, resulting in interpolated polar coordinates paired with interpolated z coordinates.

The interpolated coordinates of the line segments are representative of a boundary between the rim 225A and the lens 260A along the front face 265. The interpolated coordinates of the convex hull are representative of a boundary of the lens 260A front face 265 alone. Therefore, in preprocessing block 129, the lens 260A front face 265 boundary may be determined by, at each regular angle interval, selecting either the coordinate pair from the line segments, or the coordinate pair from the convex hull, with the smaller radius. Selected coordinate pairs from the line segments represent an overlap or collision, and the lens 260A may be adapted to the shape of the rim 225A by changing shape. This mimics physical spectacles and lenses, as when fabricating physical lenses the lenses are cut to conform with the rim of the physical spectacles. Selected coordinate pairs from the convex hull represent the unaffected boundary of the lens 260A. In some models 200, the lenses 260A-B are not surrounded completely by rims 225A-B, and for example have an opening at the bottom. For those models, the demonstration lenses represent a reasonable approximate boundary for the lens 260A, to prevent a modeled lens with a portion of the front face 265 extending infinitely through the opening in the rim 225A.

Once the boundary is determined in preprocessing block 129, vertices of the lens surface 265 outside the boundary may be discarded in block 130, using known functions to determine whether points, vectors, or planes are within a boundary or polygon.

Next, in block 131, to improve final rendering and/or fabrication, triangle slivers may be reduced using an algorithm which identifies triangles with long and thin shapes, for example using a Delaunay triangulation of the undiscarded vertices of the lens front surface 265. At this point, the lens 260A front surface 265 has been processed, and may accurately represent the front surface of a physical lens cut to fit into a rim of physical spectacles represented by the rim 225A of the spectacles frame 210 model.

The preprocessing operations at blocks 125-131 generally may be repeated in preprocessing blocks 133-139, with respect to the lens 260A back surface 266. In preprocessing block 133, similar to preprocessing block 123, the faces of the lens 260A that correspond to the back surface 266 may be selected by selecting those faces with normal vectors with a z component less than 0.5, and therefore generally facing backward.

In preprocessing block 134, the line segments resulting from intersections between the selected faces of the lens 260A from preprocessing block 133 and the faces of rim 225A may be identified. In order to determine whether a pair of faces intersect, an intersection algorithm may be used: for example, the Badouel ray-triangle intersection algorithm, the Baldwin-Weber ray-triangle intersection algorithm, or the Moller-Trumbore intersection algorithm, potentially modified to accept two planes rather than a ray and a plane, and to report only the presence of a collision between the two faces in the pair.

In preprocessing block 135, the convex hull of the vertices of the faces in the back face 266 may be calculated. As the faces in the back plane 265 may be determined in preprocessing block 133, the operations of preprocessing block 135 may be performed before or in parallel to the operations of preprocessing block 134.

With the operations at both preprocessing blocks 134 and 135 completed, the x and y coordinates of the convex hull from block 135, as well as of each identified line segment from block 134, may be converted to polar coordinates, centered on the geometric center 267 in preprocessing block 136. Thus, the line segments can be described by two points, each including a pair of polar coordinates, and a z coordinate. Likewise, points along the convex hull can also be described by a pair of polar coordinates, and a z coordinate. Next, points among the line segments are interpolated at regular angular intervals along the polar coordinates, resulting in interpolated polar coordinates paired with interpolated z coordinates. Additionally, points along the convex hull also may be interpolated at the same regular angular intervals along the polar coordinates, resulting in interpolated polar coordinates paired with interpolated z coordinates.

The interpolated coordinates of the line segments are representative of a boundary between the rim 225A and the lens 260A along the back face 266. The interpolated coordinates of the convex hull are representative of a boundary of the lens 260A back face 266 alone. Therefore, in preprocessing block 137, the lens 260A back face 266 boundary may be determined by, at each regular angle interval, selecting either the coordinate pair from the line segments, or the coordinate pair from the convex hull, with the smaller radius. Selected coordinate pairs from the line segments represent an overlap or collision, and the lens 260A must adapt to the shape of the rim 225A by changing shape. This mimics physical spectacles and lenses, as when fabricating physical lenses the lenses are cut to conform with the rim of the physical spectacles. Selected coordinate pairs from the convex hull represent the unaffected boundary of the lens 260A. In some models 200, the lenses 260A-B are not completely surrounded by rims 225A-B, and for example have an opening at the bottom. For those models, the demonstration lenses represent a reasonable approximate boundary for the lens 260A, to prevent a modeled lens with a portion of the back face 266 extending infinitely through the opening in the rim 225A.

Once the boundary is determined in preprocessing block 137, vertices of the lens back surface 266 outside the boundary may be discarded in block 138, using known functions to determine whether points, vectors, or planes are within a boundary or polygon.

Next, in block 139, to improve final rendering and/or fabrication, triangle slivers are reduced using an algorithm which identifies triangles with long and thin shapes, for example using a Delaunay triangulation of the undiscarded vertices of the lens 260A back surface 266. At this point, the lens 260A back surface 266 has been processed, and will accurately represent the back surface of a physical lens cut to fit into a rim of physical spectacles represented by the rim 225A of the spectacles frame 210 model.

Finally, once the front surface 265 and the back surface 266 of lens 260A are properly bounded with respect to the rim 225A, the resulting modified lens 260A and spectacles frame model 210 are rotated back to their original position, restoring the original head curve angle and pantoscopic angles.

After completing the operations of block 120, including preprocessing blocks 121-140, the lens 260A model has been adjusted to accurately fit within the rim 225A of the spectacles frame model 210 of the model 200. At this point, in block 150, an update to the lens 260A can be generated to match a customer's prescription. The shape of the lens 260A is a function of the sphere power, the cylinder power, the axis, the monocular pupillary distance, the optical center height, and the index of refraction of the material of the lens 260A.

In block 151, which is shown in FIG. 1C, the radii of curvature for the lens 260A front surface 265 and the back surface 266 may be calculated. The calculation is based on the sphere power(S) which is measured in diopters (D), as well as the index of refraction (n) and the cylinder power (C). The sphere power is based on the refractive error, and is associated with a base curve (BC) of the lens 260A. The radius of curvature of the front surface 265 is calculated using a standard industry equation, such as

$${R}_{F} = \frac{n - 1}{B C}$$

The radii of curvature of the back surface 266 also may be calculated. The back surface 266 includes two radii, R_{B,1} and R_{B,2}. A value difference between R_{B,1} and R_{B,2} represents a correction for the customer's astigmatism. These radii are also calculated using standard industry equations, such as

$${R}_{B , 1} = \frac{n - 1}{S + C - B C}$$

$${R}_{B , 2} = \frac{n - 1}{S - B C}$$

Further, the radius of curvature of the demonstration lens may either be obtained or calculated using similar standard industry equations, such as

$${R}^{*} = \frac{{n}^{*} - 1}{B {C}^{*}}$$

Where BC* is a nominal base curve, for example a +4 diopter measurement, and n* is the nominal index of refraction, for example 1.59.

In block 152, the lens 260A may be rotated and translated. The front surface 265 of the lens 260A is fitted to find the sphere center. The geometric center 267 of the lens 260A is represented as (X_{gc′}, Y_{gc′}, Z_{gc}), and the sphere center is represented as (X_{sc′}, Y_{sc′}, Z_{sc}). Using these representation, the head curve angle is calculated as

$$θ = {tan}^{- 1} ( \frac{{x}_{gc} - {x}_{sc}}{{z}_{gc} - {z}_{sc}} )$$

and the pantoscopic angle is calculated as

$$ϕ = {tan}^{- 1} ( \frac{{y}_{g c} - {y}_{s c}}{{z}_{g c} - {x}_{s c}} )$$

New coordinates for the lens 260A vertices may be obtained by rotating the lens surfaces 265, 266 by θ about the y axis, and by an angle of φ about the x axis so that the lens surfaces 265, 266 are parallel to the frontal plane. Then, the lens 260A may be translated so that the geometric center 267 of the front surface of the lens is at the origin.

In block 153, new z coordinates for all vertices of the front surface 265 of the lens 260A are calculated, in order to represent the prescription measurements. The center of the front surface 265 sphere may be represented as (−ΔX,−ΔY,−R_{F}), where ΔX characterizes the horizontal decentration of the lens 260A attributable to the difference between the pupillary distance of the customer, and the pupillary distance of the frame; ΔY characterizes vertical decentration of the lens 260A attributable to any deviation of the optical center height from the vertical geometric center 267, and R_{F} is the radius of curvature of the front surface 265 calculated in block 151.

For each vertex of the front surface 265, having x,y coordinates, the z coordinate of the x,y,z coordinate pair for the respective vertex is calculated by

$$z = {[ {R}_{F}^{2} - ( {x}^{′ 2} + {y}^{′ 2} ) ]}^{1 / 2} - {R}_{F}$$

$$where$$

$${x}^{′} = x + Δ$$

$${y}^{′} = y + Δ y$$

In block 154, new z coordinates for all vertices of the back surface 266 of the lens 260A are calculated, in order to represent the prescription measurements. The center of a torus corresponding to the back surface 266 is (−Δx,−Δy,−(R_{B}+t)), where R_{B} is the radius of curvature of the back surface 266 demonstration lens 260A, and t is the desired lens thickness at the optical center. The z coordinates of the vertices of the back surface 266 calculated by

$$z = {\{ {[ {( {R}_{B , 2}^{2} - {x}^{′ 2} )}^{1 / 2} + ( {R}_{B , 1} - {R}_{B , 2} ) ]}^{2} - {y}^{′2} \}}^{1 / 2} - ( {R}_{B , 1} + t )$$

where x′ and y′ are transformed by

$$[ \begin{matrix}{x}^{′} \\ {y}^{′} \\ 1\end{matrix} ] = [ \begin{matrix}cos α & - sin α & Δ x \\ sin α & cos α & Δ y \\ 0 & 0 & 1\end{matrix} ] [ \begin{matrix}x \\ y \\ 1\end{matrix} ]$$

and α is the astigmatism angle in radians.

In block 155, the sides of the lens 260A are reconstructed by finding the convex hulls of the front surface 265 and back surface 266, interpolating points at fixed angular interfaces, and creating revised triangular faces from the interpolated points.

In block 156, the rotation and translation performed in block 152 is reversed, placing the lens 260A′ at the same initial position as the lens 260A was located at the beginning of the replacement operation performed at block 150 of the protocol 100.

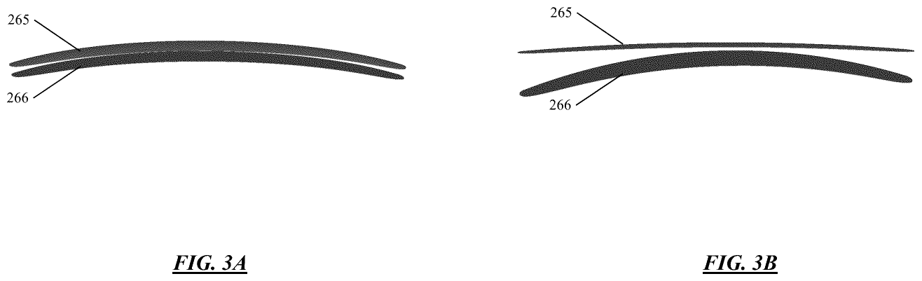

FIG. 3A depicts one example of a front surface 265 and a back surface 266 of a lens before the replacement operation is performed at block 150, and FIG. 3B depicts one example of the front surface 265 and the back surface 266 after completing the replacement operation at block 150.

After completing the replacement operation at block 150, including the operations of blocks 151-156, the lens 260A model has been adjusted to accurately reflect the prescription of a customer or user, and to fit within the rim 225A of the spectacles frame model 210 of the model 200. At this point, in block 160 an update to the spectacles frame 210 can be generated to reflect the bending of the frame 210 caused by the reshaped lens 260A′ or lenses 260A-B′. The operations of block 160 may be repeated for each of the lenses 260A-B′ in the model 200.

In block 161, shown in FIG. 1D, the face front 215 may be rotated by the head curve angle about the y axis and the pantoscopic angle about the x axis, resulting in the lens 260A being parallel to the frontal plane. In block 162, the edge points of the demonstration lens 260A are interpolated at fixed radial angular intervals, and the edge points of the personalized lens 260A′ are interpolated at the same fixed radial angular intervals.

In block 163, for each fixed radial angular interval, a bend angle is determined. For the edge points at the fixed radial angular interval of the demonstration lens 260A, the demonstration tangent angle is calculated as

$$θ = {sin}^{- 1} \frac{r}{R}$$

where R is the radius of curvature of the demonstration lens 260A, and r is the distance from the geometric center 267 of the demonstration lens 260A in the frontal plane. Likewise, the same equation may be used to calculate the personalized tangent angle of the personalized lens 260A′, where R is the radius of curvature of the personalized lens 260A′ and r is the distance from the geometric center 267 of the personalized lens 260A′ in the frontal plane. For each pair of fixed radial angular intervals between the demonstration lens 260A and the personalized lens 260A′, the bend angle may be the difference between the demonstration tangent angle and the personalized tangent angle.

In block 164, the face front 215 may be flattened by rotating and translating the vertices aligned with each fixed radial angular interval. A vertex may be aligned with a fixed radial angular interval if that vertex is closer to that fixed radial angular interval than another fixed radial angular interval. Each aligned vertex may be rotated by the bend angle relative to the frontal plane and is translated so that the vertex aligns with the personalized lens 260A′ edge point determined in block 162. Flattening the face front 215 determines a face contour of the spectacles frame 210. As flattening the face front 215 is based on the differences between the demonstration lens 260A and personalized lens 260A′, the face contour is based on the rim contour.

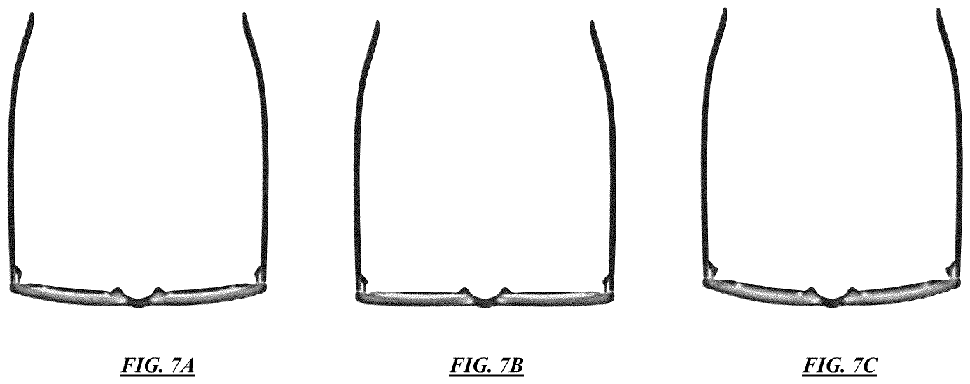

In block 165, the temple arm (such as those shown on the spectacles in FIGS. 7A-C) are repositioned. The front-most vertex may be ascertained, and the closest fixed radial angular interval to that front-most vertex may be determined. The temple arm may be rotated in the same manner as the face front 215 is rotated in block 164. Alternatively, repositioning the temple arm can include bending the end pieces of the model 200 inwards or outwards until the temple arm is brought into alignment. One method can include capturing an original vector of the temple arm, before the face front 215 is flattened. Then, once the flattening of the face front 215 is complete and has affected the direction of the temple arm, a revised vector of the temple arm can be captured. Next, the temple arm can be moved from aligning with the revised vector to aligning with the original vector. Bending the end pieces can involve modeling bending of the hinges 430A, or in the case of some models 200 an elbow component connecting the face front 215 to the temple arm. Modeling the bending of the end pieces can involve a simple stretching or compacting of the 3D model, or it may involve determining which components are pliable relative to one another, and proportionally modeling bending in proportion to the size and pliability of the components of the end piece.

Block 165 can also include repositioning nose bridges as well. Nose bridge repositioning can use any of the above-disclosed methods for modeling bending or flattening, and in some example nose bridges may include pliable components which may be modeled in a similar manner to pliable components of the end piece with respect to bending the nose bridge.

In block 166, the rotation and translation performed in block 161 may be reversed, placing the model 200 at the same initial position as the lens 260A was located at the beginning of the replacement operation performed at block 160 of the protocol 100. The process may be repeated for any additional lenses 260B′.

The operations performed at block 170 may simulate the bench alignment that is performed on physical spectacles with customized lenses after fabrication, in order to assure quality standards are met. Bench alignment ensures the angle of temple arm splay and the pantoscopic angle of the model 200 are within specification. First, the face front 215 may be checked for edges 230A-B curving away from or towards a potential wearer's face. If the edges 230A-B curve away or towards, the current angles of the temple arms are recorded. The face front 215 may be rotated around the y axis, through the bridge 220, in order to flatten the face front 215. Afterward, the temple arms may be rotated to return the arms to their original angle.

In block 180, the 3D model file of the spectacles model 200′, which include personalized lenses 260A-B, may be written out. The 3D model file may be the same format as the file read in block 110, or the format may be different, and may include additional data points, functions, and features. The 3D model file may be displayed to a user or customer using an output interface, or the 3D model file may be sent to a manufacturer or fabricator to assist in manufacturing physical spectacles with physical lenses generally conforming with the personalized spectacles model 200′. The 3D model file may also be stored in a non-transitory machine-readable storage medium or memory, for future utilization, including as training data for a machine learning or artificial intelligence model.

The spectacles model 200′ may also be output as one or more still images, or a video file. In particular, the still images may include a front view, a side view, a top view, and an isometric view. The renderings may also be presented in a photorealistic mode, which may use the textures including in the original input file. As an alternative, a schematic mode may use digital color to emphasize changes to the front face 225′ and lenses 260A-B′.

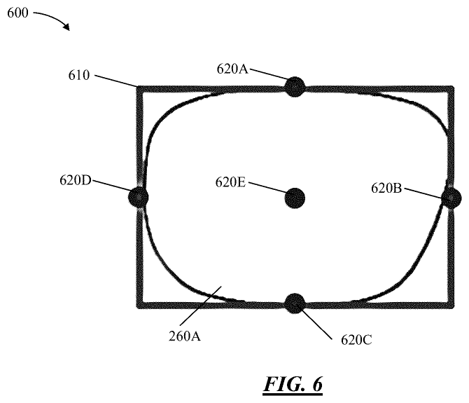

In block 190, the personalized spectacles model 200′ may be analyzed for certain key attributes, in order to assess whether the combination of prescription, frame style, and lens material are appropriate for the customer. This information can be communicated to the user in the form of raw data or status messages. For example, customers may be concerned about excess lens thickness in their spectacles. To address this, thickness values taken at various points around the edge of the lens may be provided to the user. Because the front surface 265 and back surface 266 vertices may not be aligned, and because the thickness at points that do not correspond to model vertex locations may be desired, spline interpolation in polar coordinates can be utilized to find the depths of the front surface 265 and back surface 266 edges and in turn determine the edge thicknesses. FIG. 6 depicts one example of a lens thickness approximation model 600 at several points on the lens 260A′ by using a rectangle 610, outputting thicknesses at edge points 620A-D and center point 620E

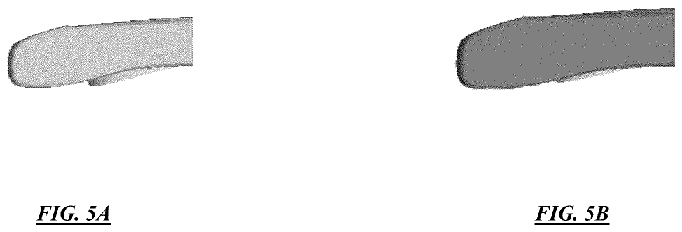

In another example, customers may be concerned with the extent to which the edge of the lens protrudes beyond the rim. A large degree of protrusion can be considered aesthetically undesirable. FIG. 5A depicts one example of a lens protrusion due to deflection or bending, while FIG. 5B depicts another example having less lens protrusion due to reduced bending in the frame. Spline interpolation in polar coordinates as described above can be used to determine the coordinates of the back lens surface 226 edge. For each interpolated point, the vertex on the back surface of the face front 215 is found that is closest to the back lens surface 226 edge in the sense of having the smallest Euclidean distance in the frontal plane. The depth difference between the lens edge point and the closest point on the back surface of the face front may be calculated, resulting in a measure of protrusion.

In yet another example, manufacturability of the lens 260A′ is impacted by the lens shape, the degree of decentration, and the diameter of the physical lens blank from which the lens modeled by lens 260A′ is cut. Under certain circumstances, the lens blank may not be large enough to accommodate the desired shape and decentration of lens 260A′, a phenomenon known as “cutout”. In order to determine whether there is a cutout issue, maximum distance between the lens's optical center and its edge is determined and compared to the lens blank radius. If the distance is not sufficiently less than the less blank radius, a cutout issue may be present.

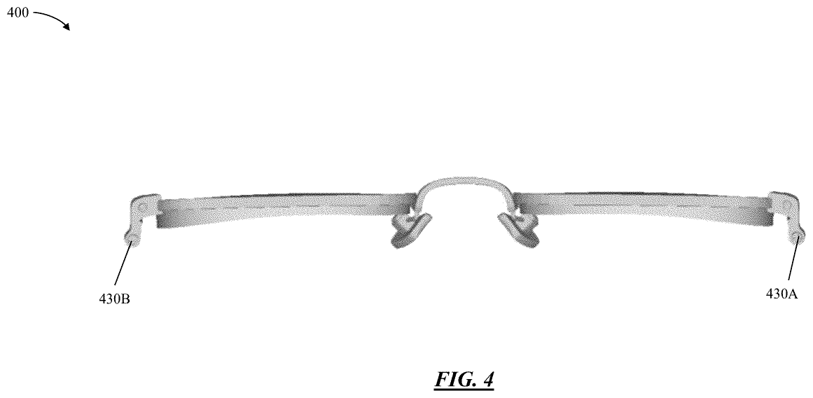

In still another example, the temple arm may not be able to fully close if the lens 260A′ is too thick in the area near the temple arm hinge 430A, shown in FIG. 4. In order to assess the likelihood of this phenomenon, the depth of the temple arm hinge 430A is compared to the depth of the back surface 266 of the lens 260A′ edge in the vicinity of the hinge 430A.

In addition to identifying structural or preference issues, in block 190 personalized models for several frame styles and lens materials can be analyzed, and the results can be compared in order to recommend a particular frame style or lens material for a given customer or user. A preferred recommendation may be a configuration that has the lowest degree of lens protrusion for a given prescription strength and pupillary distance.

Therefore, FIGS. 1-7 depict a computer-implemented method implemented as protocol 100, which may include obtaining a first refractive error, diopter measurement, or sphere power associated with a user or the prescription of the user, as used in block 150. The method may include determining a first focal length or requisite lens power of a first three-dimensional lens 260A based on the measurement, the first three-dimensional lens 260A including a lens perimeter face 265 intersecting a first lens frontal plane. Focal length (f) can be calculated using the Lensmaker's equation

$$\frac{1}{f} = ( n - 1 ) [ \frac{1}{{R}_{1}} - \frac{1}{{R}_{2}} + \frac{( n - 1 ) d}{n {R}_{1} {R}_{2}} ] \frac{R}{2} ,$$

where n is the refractive index of the lens 260A material, R₁ is the radius of curvature of the front surface 265 of the lens 260A, R₂ is the radius of curvature of the back surface 266 of the lens 260A, and d is the thickness of the lens 260A. As discussed above, the radius of curvature can be calculated based on the first refractive error, diopter measurement, or sphere power associated with the user.

It should be emphasized that the three-dimensional lenses 260A-B may be characterized by multiple focal lengths, such as when the three-dimensional lenses 260A-B are for correcting astigmatism.

The method may also include obtaining a three-dimensional spectacles frame model 210, as disclosed in block 110, the three-dimensional model including a first rim inner face 225A intersecting a spectacle frontal plane 215. The method may further include determining a first lens contour or lens boundary of the first lens perimeter face 265, the first lens contour conforming to the first rim inner face 225A, as disclosed in block 120. The method additionally may include determining a rim contour or rim boundary of the three-dimensional spectacles frame model 210, the rim contour conforming to the first focal length, due to the rim contour conforming to the personalized lens 260A′ which has been personalized in part based on the first focal length. The method may yet further include producing a validity report, the validity report indicating conformance between the three-dimensional spectacles model 200′ with the determined rim contour, and the first three-dimensional lens 260A with the determined first lens contour, as disclosed in block 170 as the virtual bench alignment.

the validity report may include a depiction of a virtual representation of the three-dimensional spectacles frame model 210′ with the determined rim contour, the first three-dimensional lens 260A′ with the determined first lens contour, and the first lens perimeter face 265 in contact with the first rim inner face 225A, in the form of a revised 3D model file, video, or one or more still images, as disclosed in block 180. Conformance may be indicated by explicit indicators of the three-dimensional spectacles model 200 conforming or not conforming with first three-dimensional lens 260A, such as colors or markings indicating lack of physical conformance to expected specifications, or physical possibility. Conformance may be indicated by presenting to a user a contradictory or physically impossible relationships between the three-dimensional spectacles model 200 and the first three-dimensional lens 260A, with the user inferring a lack of conformance based on their observation of a physically impossible or improbable three-dimensional spectacles model 200.

The three-dimensional spectacles model 200 may include a second rim inner face 225B intersecting the model frontal plane 215. The method also may include obtaining a second refractive error, diopter measurement, or sphere power associated with the user or the prescription of the user. The method may include determining a second focal length or requisite lens power of a second three-dimensional lens 260B based on the second measurement, the second three-dimensional lens 260B including a second lens perimeter face intersecting a second lens frontal plane. The method additionally may include determining a second lens contour of the second lens perimeter face, the second lens contour or second lens boundary conforming to the second rim inner face 225B, again as disclosed in block 120. The method may yet further include determining a second rim contour or second rim boundary of the three-dimensional spectacles frame model 210, the second rim contour conforming to the second focal length, due to the second rim countour conforming to the personalized lens 260B′ which has been personalized in part based on the second focal length. In addition, the method may include displaying a virtual representation of the three-dimensional spectacles frame model 210′ with the determined rim contour and the determined second rim contour, the first three-dimensional lens 260A′ with the determined first lens contour, the second three-dimensional lens 260B′ with the determined second lens contour, the first lens perimeter face in contact with the first rim inner face 225A, and the second lens perimeter face is in contact with the second rim inner face 225B, in the form of a revised 3D model file, video, or one or more still images, as disclosed in block 180.

The visual representation may be depicted from a first perspective. The method may further include receiving input correlated to a rotation of the visual representation to a second perspective from a user or a customer, such as from a keyboard, mouse or touchscreen. The method may also include depicting the visual representation from the second perspective, determined based upon that input—an input requesting to rotate the spectacles model 200′ to the right can result in depicting the spectacles model 200′ as rotated to the right.

In some aspects, the method may further include obtaining a refractive index of the first three-dimensional lens 260A′, as discussed in block 151. The method may also include determining the first focal length of the first three-dimensional lens 260A′ based on the measurement and the refractive index.

The method may include obtaining a lens thickness threshold. The method may also include determining a thickness value of the first three-dimensional lens 260A′, for example as discussed with respect to FIG. 6. The method may include, based on the thickness value exceeding the lens thickness threshold, indicating a high thickness status, for example in the validity report, or as disclosed above with respect to block 190.

The method may include obtaining a lens protrusion threshold. The method may also include determining a protrusion value of the first three-dimensional lens 260A′ when the first lens perimeter face 265 in contact with the first rim inner face 225A, for example as discussed with respect to FIGS. 5A-B. The method may include, based on the protrusion value exceeding the lens protrusion threshold, indicating a high protrusion status, for example in the validity report, or as disclosed above with respect to block 190.

The three-dimensional spectacles model 200 may further include a hinge 430A. The method also may include determining an interference threshold based on a depth of the hinge 430A. The method may include determining a lens back depth value of the first three-dimensional lens 260A′ when the first lens perimeter face 265 in contact with the first rim inner face 225A based on the lens back depth value exceeding the interference threshold indicating a high interference status, for example in the validity report, or as disclosed above with respect to block 190. High interference status can be indicative that the thickness of the lens 260A′ is so high relative to the thickness of the three-dimensional spectacles frame 210 that the temple arm may not be able to fully close at temple arm hinge 430A.

In some aspects, the three-dimensional spectacles frame model 210 corresponds to a physical pair of spectacles, the first three-dimensional lens 260A corresponds to a physical lens, configured to improve vision of the user, and the virtual representation corresponds to the physical pair of spectacles including the physical lens. Further, the physical pair of spectacles to which the virtual representation corresponds may have been aligned, flattened, or bent to conform to manufacturer or consumer expectations regarding alignment, flattening, or bending of a pair of spectacles.

A modeled parameter of the first three-dimensional lens 260A may be calculated according to an equation, for example those presented in blocks 151-154. Alternatively, the modeled parameter may be may be generated based on empirical or modeled lens data from lens manufacturers. In addition, a manufacturing parameter of the physical lens can be calculated according to the same equation or empirical or modeled lens data. Further, the parameter may be the first focal length, the determined first lens contour, or a combination thereof.

The three-dimensional spectacles model 200 may be obtained from an input file in a modeling format. Additionally, the validity report may include a virtual representation of the three-dimensional spectacles model 200′ with the determined rim contour, the first three-dimensional lens 260A′ with the determined first lens contour, and the first lens perimeter face 265 in contact with the first rim inner face 225A, all in the modeling format.

The method may include determining a sagittal plane of the first three-dimensional lens 260A based on a top thickness, a bottom thickness, and a center thickness, as depicted in FIG. 6. The method also may include determining a coronal plane of the first three-dimensional lens 260A based on a left thickness, a right thickness, and the center thickness, again as depicted in FIG. 6. The method may further include determining a lens surface based on the sagittal plane and the coronal plane, as disclosed in block 190 with respect to the thickness approximation model 600. The validity report may indicate conformance between the three-dimensional spectacles models 210′ with the determined rim contour, and the first three-dimensional lens 260A′ with the determined first lens contour and the determined lens surface.

Determining a first lens contour of the first lens perimeter face 265, the first lens contour conforming to the first rim inner face 225A, may include selecting one or more edge facets of lens facets of the first three-dimensional lens 260A, the one or more edge facets including an edge normal vector approximately oriented towards a geometric center 267 of the first three-dimensional lens 260A and approximately perpendicular to a sagittal axis, as disclosed in blocks 125 and 133. Additionally, the determining may include determining a convex hull based on the one or more edge facets, as disclosed in blocks 127 and 135. Still further, the determining may include selecting one or more surface facets of the first rim inner face 225A, the one or more surface facets including a surface normal vector approximately oriented toward the sagittal axis, as disclosed in block 123. Also, the determining may include determining one or more line segments, the one or more line segments resulting from intersections between the one or more edge facets and the one or more surface facets, as disclosed in blocks 126 and 134. The determining also may include, based on the one or more line segments and the convex hull, determining the first lens contour, as disclosed in blocks 128-129 and 136-137.

Determining the rim contour of the three-dimensional spectacles frame model 210′, the determined first rim contour conforming to the first focal length, may include determining a base front radius of curvature of the three-dimensional spectacles associated with the inner rim as disclosed in block 153, and a base back radius of curvature of the three-dimensional spectacles model associated with the inner rim as disclosed in block 154. The determining also may include calculating a lens front radius of curvature of the first three-dimensional lens 260A based on the first focal length, and a lens back radius of curvature based on the first focal length. The determining may include updating the one or more surface normal vectors based on a first variation between the base front radius of curvature and the lens front radius of curvature, and a second variation between the base back radius of curvature and the lens back radius of curvature. The determining may additionally include determining the rim contour based on the updated one or more edge normal vectors, as disclosed in block 155.

The three-dimensional spectacles frame model 210 may include an arm with an original arm angle. The method also may include, based on the updated one or more edge normal vectors, determining an updated arm angle, as disclosed in blocks 162-164. The method may include, based on the updated arm angle, calculating an arm rotation angle of the arm, the arm rotation angle and the updated arm angle equal to the original arm angle, as disclosed in block 165.

The method may include determining a face contour of the three-dimensional spectacles model 210, with the face contour based on the rim contour. In particular, as the rim is connected to or a part of the spectacles face front 215, changes to the rim contour affect the spectacles face front, as disclosed in blocks 161-164.

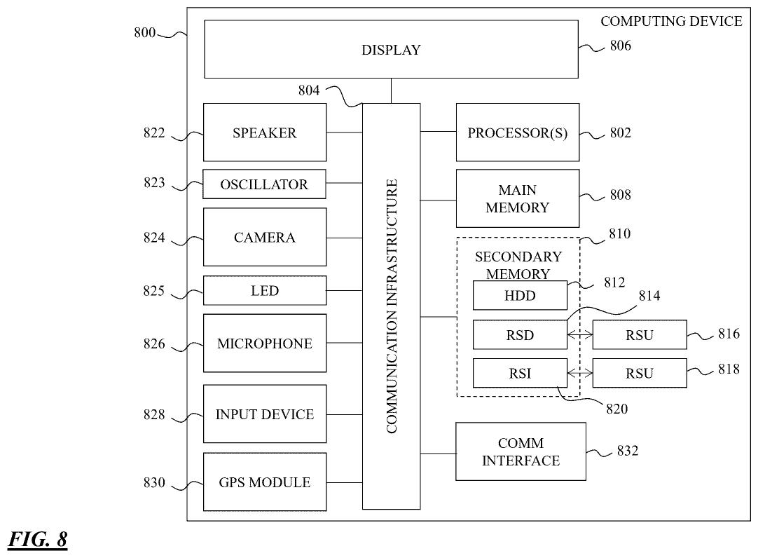

FIG. 8 is a block diagram of one example of an architecture of a computing device 800 that may be used in a system to implement a protocol, such as protocol 100, in accordance with some embodiments. Computing device 800 may be a cellular phone, a tablet, a desktop computer, a laptop computer, a server, a distributed computing environment, or any other suitable computing device as will be understood by one of ordinary skill in the art. As shown in FIG. 8, computing device 800 may include one or more processors, such as processor(s) 802. Processor(s) 802 may be any central processing unit (“CPU”), microprocessor, micro-controller, or computational device or circuit for executing instructions. Processor(s) 802 may be connected to a communication infrastructure 804 (e.g., a communications bus, crossover bar, or network). Various software embodiments are described in terms of this exemplary computing device 800. After reading this description, it will be apparent to one of ordinary skill in the art how to implement one or more disclosed methods using a mobile computing device 800 that may include other architectures and/or components. It should be understood that a computing device 800 implementing one or more of the disclosed methods may include some, all, or additional functional components as those of the computing device 800 illustrated in FIG. 8.

Computing device 800 may include a display 806 that displays graphics, video, text, and other data received from the communication infrastructure 804 (or from a frame buffer not shown) to a user. Examples of such displays 806 include, but are not limited to, LCD screens, LED display, OLED display, touch screen (e.g., capacitive, resistive optical imaging, infrared), and a plasma display, to name a few possible displays. Computing device 100 also may include a main memory 808, such as a random access (“RAM”) memory, and may also include a secondary memory 810. Secondary memory 810 may include a more persistent memory such as, for example, a hard disk drive (“HDD”) 812 and/or removable storage drive (“RSD”) 814, representing a magnetic tape drive, an optical disk drive, solid-state drive (“SDD”), or the like. In some embodiments, removable storage drive 814 may read from and/or writes to a removable storage unit (“RSU”) 816 in a manner that is understood by one of ordinary skill in the art. Removable storage unit 816 may represent a magnetic tape, optical disk, or the like, which may be read by and written to by removable storage drive 814. As will be understood by one of ordinary skill in the art, the removable storage unit 816 may include a tangible and non-transient machine-readable storage medium having stored therein computer software and/or data.

In some embodiments, secondary memory 810 may include other devices for allowing computer programs or other instructions to be loaded into computing device 800. Such devices may include, for example, a removable storage unit (“RSU”) 818 and a corresponding interface (“RSI”) 820. Examples of such units 818 and interfaces 820 may include a removable memory chip (such as an erasable programmable read only memory (“EPROM”)), programmable read only memory (“PROM”)), secure digital (“SD”) card and associated socket, and other removable storage units 818 and interfaces 820, which allow software and data to be transferred from the removable storage unit 818 to computing device 800.

Computing device 800 may also include a speaker 822, an oscillator 823, a camera (or other image capture device or sensor) 824, a light emitting diode (“LED”) 825, a microphone 826, an input device 828, and a global positioning system (“GPS”) module 830. Examples of input device 828 include, but are not limited to, a keyboard, buttons, a trackball, or any other interface or device through which a user may input data. In some embodiments, input device 828 and display 806 are integrated into the same component or device. For example, display 806 and input device 828 may be touchscreen through which a user uses a finger, pen, and/or stylus to input data into computing device 800.

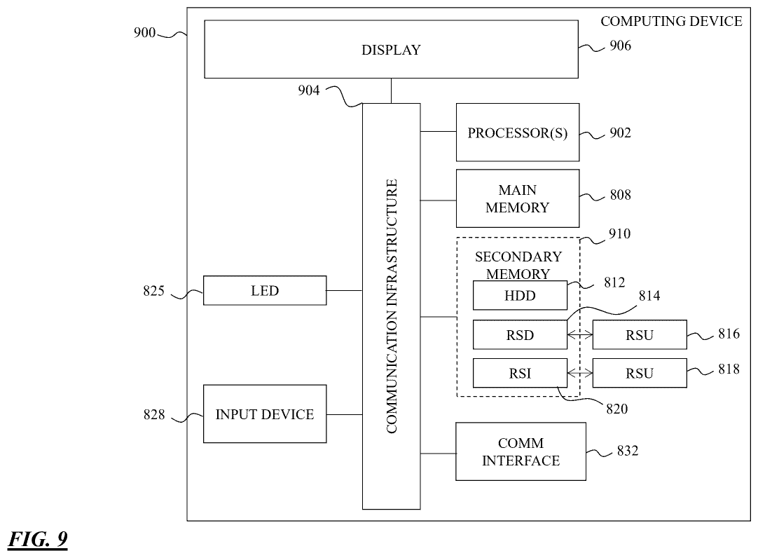

Computing device 800 also may include one or more communication interfaces 832, which allows software and data to be transferred between computing device 800 and external devices such as, for example, another computing device 900 (see FIG. 9) that may be locally or remotely connected to computing device 800. Examples of the one or more communication interfaces 832 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 832 may also include a wireless interface configured for short-range communication, such as near field communication (“NFC”), Bluetooth, or other interface for communication via another wireless communication protocol.

Software and data transferred via the one or more communications interfaces 832 may be in the form of signals, which may be electronic, electromagnetic, optical, or other signals capable of being received by communications interfaces 832. These signals may be provided to communications interface 832 via a communications path or channel. The channel may be implemented using wire or cable, fiber optics, a telephone line, a cellular link, a radio frequency (“RF”) link, or other communication channels. The terms “non-transient computer program medium” and “non-transient computer readable medium” refer to media such as removable storage units 816, 818, or a hard disk installed in hard disk drive 812. These computer program products provide software to computing device 800. Computer programs (also referred to as “computer control logic”) may be stored in main memory 808 and/or secondary memory 810. Computer programs may also be received via the one or more communications interfaces 832. Such computer programs, when executed by a processor(s) 802, enable the computing device 800 to perform the methods discussed herein.

In some embodiments, where the method is partially or entirely implemented using software, the software may be stored in a computer program product as firmware and/or loaded into computing device 800 using removable storage drive 814, hard drive 812, and/or communications interface 832. The software, when executed by processor(s) 802, may cause the processor(s) 802 to perform the functions of the methods described herein. In some embodiments, the method may be implemented primarily in hardware using, for example, hardware components such as application specific integrated circuits (“ASICs”). Implementation of the hardware state machine so as to perform the functions described herein will be understood by persons skilled in the art. In some embodiments, the methods may be implemented using a combination of both hardware and software.

In some embodiments, the display 106 may be used as a light source and/or to display a reference pattern. A front-facing camera 824 of the computing device 800, i.e., the camera that is oriented to point in the same direction as the display 806, may be used as the image capture device. One of ordinary skill in the art will understand that other configurations are possible.

FIG. 9 is a block diagram of one example of an architecture of a computing device 900 that may be used in a system to implement a protocol, such as protocol 100, in accordance with some embodiments. Computing device 900 is substantially similar to computing device 800, and unless indicated otherwise implements some or all of the same components, or the same functionality of the components of computing device 800. In particular, processor 902 may be substantially similar to processor 802, though processor 902 may have materially higher processing capacity. Main memory 908 may be substantially similar to main memory 908, though main memory 908 may have materially larger storage capacity. Secondary memory 910 may be substantially similar to secondary memory 810, though secondary memory 910 may have materially larger storage capacity. Computing device 900 is optional. Computing device 800 can be directed to implementing some or all of protocol 100, while computing device 900 can be directed to implementing some of protocol 100, or assisting computing device 800 in implementing protocol 100. Computing device 900 can predominantly implement protocol 100 and assist computing device 800, by storing relevant data in secondary memory 910 or by offloading processing related to protocol 100 from processor 802 to processor 902.

Computing device 900 may be a desktop computer, a laptop computer, a server, a distributed computing environment, or any other suitable computing device as will be understood by one of ordinary skill in the art.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, such as, but not limited to protocol 100 can be implemented as one or more computer programs, i.e., one or more modules of computer program instructions encoded on a tangible non-transitory program carrier for execution by, or to control the operation of, a data processing apparatus (or a computer system). According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++), procedural programming languages (e.g., C or assembly language), or firmware. In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application can invoke API calls provided by the operating system to facilitate functionality described herein.

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub programs, or portions of code. A computer program can be deployed to be executed on one computer or on multiple computers that are located at one site or distributed across multiple sites and interconnected by a communication network.

The processes, protocols, and logic flows described in this specification can be performed by one or more programmable computers executing one or more computer programs to perform functions by operating on input data and generating output. The processes, protocols, and logic flows can also be performed by, and apparatus can also be implemented as, special purpose logic circuitry, such as an FPGA (field programmable gate array), an ASIC (application specific integrated circuit), one or more processors, or any other suitable logic.

Computers suitable for the execution of a computer program include, by way of example, general or special purpose microprocessors or both, or any other kind of central processing unit (e.g., processors 802, 902). Generally, a CPU will receive instructions and data from a read only memory or a random-access memory or both. The essential elements of a computer are a central processing unit for performing or executing instructions and one or more memory devices for storing instructions and data (e.g., main memory 808, 908). Generally, a computer will also include, or be operatively coupled to receive data from or transfer data to, or both, one or more mass storage devices for storing data, such as magnetic, magneto optical disks, or optical disks (e.g., secondary memory 810, 910). However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back end component, such as a data server, or that includes a middleware component, such as an application server, or that includes a front end component, such as a computer having a graphical user interface or a Web browser through which a user can interact with an implementation of the subject matter described in this specification, or any combination of one or more such back end, middleware, or front end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, element, block, step, feature, object, benefit, advantage, or equivalent to the public, regardless of whether it is or is not recited in the claims. It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements, blocks, or steps does not include only those elements, blocks, or steps but may include other elements, blocks, or steps not expressly listed or inherent to such process, method, article, or apparatus. An element preceded by “a” or “an” does not, without further constraints, preclude the existence of additional identical elements in the process, method, article, or apparatus that comprises the element unless the context clearly and unambiguously dictates otherwise.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A computer-implemented method, comprising:
determining a first focal length of a first three-dimensional lens based on a first measurement, the first three-dimensional lens including a first lens perimeter face intersecting a first lens frontal plane;
obtaining a three-dimensional spectacles model, the three-dimensional model including a first rim inner face intersecting a spectacle frontal plane;
determining a first lens contour of the first lens perimeter face, the first lens contour conforming to the first rim inner face;
determining a rim contour of the three-dimensional spectacles model, the rim contour conforming to the first focal length; and
producing a validity report, the validity report indicating conformance between the three-dimensional spectacles model with the determined rim contour, and the first three-dimensional lens with the determined first lens contour.

2. The computer-implemented method of claim 1, wherein the validity report includes a depiction of a virtual representation including:
the three-dimensional spectacles model with the determined rim contour,
the first three-dimensional lens with the determined first lens contour, and
the first lens perimeter face in contact with the first rim inner face.

3. The computer-implemented method of claim 2, wherein:
the three-dimensional spectacles model corresponds to a physical pair of spectacles;
the first three-dimensional lens corresponds to a physical lens, configured to improve vision of the user; and
the virtual representation corresponds to the physical pair of spectacles including the physical lens.

4. The computer-implemented method of claim 3, wherein:
a modeled parameter of the first three-dimensional lens is calculated according to an equation;
a manufacturing parameter of the physical lens is calculated according to the equation; and
the modeled parameter and the manufacturing parameter are:
the first focal length,
the determined first lens contour, or
a combination thereof.

5. The computer-implemented method of claim 2, wherein the three-dimensional spectacles model further includes a second rim inner face intersecting the spectacle frontal plane; and
The method further comprises:
obtaining a second measurement associated with the user;
determining a second focal length of a second three-dimensional lens based on the second measurement, the second three-dimensional lens including a second lens perimeter face intersecting a second lens frontal plane;
determining a second lens contour of the second lens perimeter face, the second lens contour conforming to the second rim inner face;
determining a second rim contour of the three-dimensional spectacles model, the second rim contour conforming to the second focal length; and
displaying the virtual representation including:
the three-dimensional spectacles model with the determined first rim contour and the determined second rim contour,
the first three-dimensional lens with the determined first lens contour,
the second three-dimensional lens with the determined second lens contour,
the first lens perimeter face in contact with the first rim inner face, and
the second lens perimeter face is in contact with the second rim inner face.

6. The computer-implemented method of claim 5, wherein:
the virtual representation is depicted from a first perspective; and the method further comprises:
receiving input correlated to a rotation of the virtual representation to a second perspective; and
depicting the virtual representation from the second perspective.

7. The computer-implemented method of claim 1, further comprising:
obtaining a refractive index of the first three-dimensional lens; and
determining the first focal length of the first three-dimensional lens based on the first measurement and the refractive index.

8. The computer-implemented method of claim 1, further comprising:
obtaining a lens thickness threshold;
determining a thickness value of the first three-dimensional lens; and
based on the thickness value exceeding the lens thickness threshold, indicating a high thickness status.

9. The computer-implemented method of claim 1, further comprising:
obtaining a lens protrusion threshold;
determining a protrusion value of the first three-dimensional lens when the first lens perimeter face in contact with the first rim inner face; and
based on the protrusion value exceeding the lens protrusion threshold, indicating a high protrusion status.

10. The computer-implemented method of claim 1, wherein the three-dimensional spectacles model further includes a hinge; and
the method further comprises:
determining an interference threshold based on a depth of the hinge;
determining a lens back depth value of the first three-dimensional lens when the first lens perimeter face in contact with the first rim inner face; and
based on the lens back depth value exceeding the interference threshold indicating a high interference status.

11. The computer-implemented method of claim 1, wherein:
the three-dimensional spectacles model is obtained from an input file in a modeling format; and
the validity report includes a virtual representation of:
the three-dimensional spectacles model with the determined rim contour,
the first three-dimensional lens with the determined first lens contour, and
the first lens perimeter face in contact with the first rim inner face, in the modeling format.

12. The computer-implemented method of claim 1, further comprising:
determining a sagittal plane of the first three-dimensional lens based on a top thickness, a bottom thickness, and a center thickness;
determining a coronal plane of the first three-dimensional lens based on a left thickness, a right thickness, and the center thickness; and
determining a lens surface based on the sagittal plane and the coronal plane;
wherein:
the validity report further indicates conformance between the three-dimensional spectacles models with the determined first rim contour, and the first three-dimensional lens with the determined first lens contour and the determined lens surface.

13. The computer-implemented method of claim 1, wherein determining a lens contour of the first lens perimeter face, the first lens contour conforming to the first rim inner face further includes:
selecting one or more edge facets of lens facets of the first three-dimensional lens, the one or more edge facets including an edge normal vector approximately oriented towards a geometric center of the first three-dimensional lens and approximately perpendicular to a sagittal axis;
determining a convex hull based on the one or more edge facets;
selecting one or more surface facets of the first rim inner face, the one or more surface facets including a surface normal vector approximately oriented toward the sagittal axis;
determining one or more line segments, the one or more line segments resulting from intersections between the one or more edge facets and the one or more surface facets; and
based on the one or more line segments and the convex hull, determining the first lens contour.

14. The computer-implemented method of claim 13, wherein determining the rim contour of the three-dimensional spectacles model, the rim contour conforming to the first focal length further comprises:
determining a base front radius of curvature of the three-dimensional spectacles model associated with the first rim inner face, and a base back radius of curvature of the three-dimensional spectacles model associated with the first rim inner face;
calculating a lens front radius of curvature of the first three-dimensional lens based on the first focal length, and a lens back radius of curvature based on the first focal length;
updating the one or more surface normal vectors based on a first variation between the base front radius of curvature and the lens front radius of curvature, and a second variation between the base back radius of curvature and the lens back radius of curvature; and
determining the rim contour based on the updated one or more edge normal vectors.

15. The computer-implemented method of claim 14, wherein the three-dimensional spectacles model further includes an arm with an original arm angle; and
the method further comprises:
based on the updated one or more edge normal vectors, determining an updated arm angle; and
based on the updated arm angle, aligning the arm to the original arm angle.

16. The computer-implemented method of claim 1, further comprising:
determining a face contour of the three-dimensional spectacles model, the face contour based on the rim contour.

17. A computer-implemented method, comprising:
obtaining a measurement associated with a user;
determining a shape depth of a three-dimensional shape based on the measurement, the three-dimensional shape including a shape outer face intersecting a shape frontal plane;
obtaining a three-dimensional model, the three-dimensional model including a model inner face intersecting a model frontal plane;
determining a shape contour of the shape outer face, the shape contour conforming to the model inner face;
determining a model contour of the three-dimensional model, the model contour conforming to the shape depth; and
displaying a virtual representation of:
the three-dimensional model with the determined model contour,
the three-dimensional shape with the determined shape contour,
the shape outer face in contact with the model inner face.

18. The computer-implemented method of claim 17, further comprising:
obtaining a measurement associated with a user;
determining a shape depth of a three-dimensional shape based on the measurement, the three-dimensional shape including a shape outer face intersecting a shape frontal plane;
obtaining a three-dimensional model, the three-dimensional model including a model inner face intersecting a model frontal plane;
determining a shape contour of the shape outer face, the shape contour conforming to the model inner face;
determining a model contour of the three-dimensional model, the model contour conforming to the shape depth; and
producing a validity report, the validity report indicating conformance between the three-dimensional model with the determined model contour, and the three-dimensional shape with the determined shape contour.

19. The computer-implemented method of claim 17, wherein determining a shape contour of the shape outer face, the shape contour conforming to the model inner face further includes:
selecting one or more edge facets of lens facets of the three-dimensional shape, the one or more edge facets including an edge normal vector approximately oriented towards a geometric center of the three-dimensional shape and approximately perpendicular to a sagittal axis;
determining a convex hull based on the one or more edge facets;
selecting one or more surface facets of the model inner face, the one or more surface facets including a surface normal vector approximately oriented toward the sagittal axis;
determining one or more line segments, the one or more line segments resulting from intersections between the one or more edge facets and the one or more surface facets;
based on the one or more line segments and the convex hull, determining the first lens contour.

20. A system comprising:
a processor;
an input device, coupled to the processor;
an output device, coupled to the processor;
a memory, coupled to the processor; and
programming in the memory, wherein execution of the programming by the processor configures the system to perform the following functions:
determine a focal length of a three-dimensional lens based on a measurement, the three-dimensional lens including a lens perimeter face intersecting a lens frontal plane;
obtain a three-dimensional spectacles model, the three-dimensional model including a rim inner face intersecting a spectacle frontal plane;
determine a lens contour of the lens perimeter face, the lens contour conforming to the rim inner face;
determine a rim contour of the three-dimensional spectacles model, the rim contour conforming to the focal length; and
produce a validity report, the validity report indicating conformance between the three-dimensional spectacles model with the determined rim contour, and the three-dimensional lens with the determined lens contour.
